(19) United States
(12) Patent Application Publication
(10) Pub. No.: US 2009/0102166 A1
(43) Pub. Date: Apr. 23, 2009

(54) Airbag module

(75) Inventors: Mardoro Brown, San Antonio, TX (US); James Garvin, San Antonio, TX (US); Stephen Chapman, Oak Ridge, NC (US); Scott Caudill, Helotes, TX (US); Daniel Heath, San Antonio, TX (US)

Correspondence Address: FOLEY AND LARDNER LLP;SUITE 500, 3000 K STREET NW, WASHINGTON, DC, 20007, US

(73) Assignee: TK Holdings Inc.

(21) Appl. No.: 11/976,310

(22) Filed: Oct. 23, 2007

(51) Int. Cl. B60R 21/21; B60R 21/215

(52) U.S. Cl. 280/728.2; 280/730.2

(57) ABSTRACT

The disclosed airbag module may be used in a vehicle. The airbag may include an airbag for protecting a vehicle occupant and at least one tearable sleeve. The airbag is configured to be in a folded or rolled up state and to deploy along an interior side portion of the vehicle. The at least one tearable sleeve is coaxially or circumferentially surrounding a portion of the airbag in the folded or rolled up state.

### BACKGROUND

The present invention relates generally to the field of airbags and inflatable safety devices. More specifically, the invention relates to airbags with one or more tearable sleeves so as to maintain the airbags in a folded or rolled up condition during shipping, installation, or handling.

It is known in the art to provide side curtain airbags in vehicles of the safety and protection of the driver and passengers located in the vehicle. The curtain airbags typically include an inflatable portion that runs along the longitudinal direction of the vehicle (as opposed to the traverse direction) and a gas generator in fluid communication with the inflatable portion. The curtain airbag is folded or rolled up into a compact structure and stored in a storage space in the interior roof of the vehicle along the longitudinal direction. At the time of a crash, impact sensors, deceleration sensors or the like trigger the gas generator so as to fill up the inflatable portion of the curtain airbag, which deploys the airbag downward along the side of the vehicle so as to prevent the vehicle passengers and driver from impacting the vehicle's side walls and windows.

When an airbag is folded up, typically, strips of adhesive tape are used to keep the airbag in the folded condition, as seen in FIG. 1. FIG. 1 shows an airbag 100 that has been folded up for storage, for transport, or for installation inside a vehicle. The airbag 100 may include one or more mounting tabs 102 which have one or more apertures 104. The apertures may fit over mounting pins located in a storage compartment located along the roof of the vehicle inside the vehicle compartment. To help maintain the airbag in its folded or rolled up shape, a series of adhesive tape strips 106 are used. The adhesive tape strips have adhesive on one side, and are wrapped around portions of the folded airbag with the adhesive side in contact with the airbag.

The use of adhesive tape strips have some drawbacks. For example, many strips need to be applied along the longitudinal direction of the airbag so as to keep the entire airbag in the folded condition. Also, peeling of the adhesive tape may occur if the tape loses its adhesiveness. Finally, the tape strips do not maintain the straightness of the folded airbag if the airbag needs to be twisted during installation into the vehicle.

### SUMMARY

According to one embodiment of the present invention, an airbag module for a vehicle may comprise an airbag for protecting a vehicle occupant and at least one tearable sleeve. The airbag is configured to be in a folded or rolled up state and to deploy along an interior side portion of the vehicle. The at least one tearable sleeve coaxially surrounds a portion of the airbag in the folded or rolled up state in which the at least one tearable sleeve is a shrink wrap film.

According to another embodiment of the present invention, an airbag module for a vehicle may comprise an airbag and at least one tearable sleeve. The airbag comprises an inflatable portion and a connecting portion for connecting a gas generator in which the airbag is configured to be in a folded or rolled up condition. The at least one tearable sleeve is located circumferentially around a portion of the inflatable portion of the air bag when in the folded or rolled up condition. The at least one tearable sleeve is configured to shrink around the inflatable portion of the air bag to provide a form fit after being subjected to an application of heat.

It is to be understood that both the foregoing general description and the following detailed descriptions are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a conventional airbag which uses strips of adhesive tape so as to keep the airbag in a folded condition during storage, transportation, and installation of the airbag.

FIG. 2 is an unfolded or unrolled airbag used in one embodiment of the present invention.

FIG. 3 is the airbag of FIG. 2 in a folded or rolled up state.

FIG. 4 is the folded or rolled up airbag of FIG. 3 with tearable sleeves mounted thereon before the application of heat, according to an embodiment of the present invention.

FIG. 5 is the folded or rolled up airbag of FIG. 4 with tearable sleeves mounted thereon after the application of heat, according to an embodiment of the present invention.

FIG. 6 is the airbag module of FIG. 5 mounting inside the interior roof of a vehicle.

FIG. 7 is a comparison between a conventional airbag module and an airbag module according to an embodiment of the present invention when each are twisted 90 degrees.

FIG. 8 is another embodiment of the airbag module according to another embodiment of the present invention.

FIG. 9 is another embodiment of the airbag module according to another embodiment of the present invention the present invention.

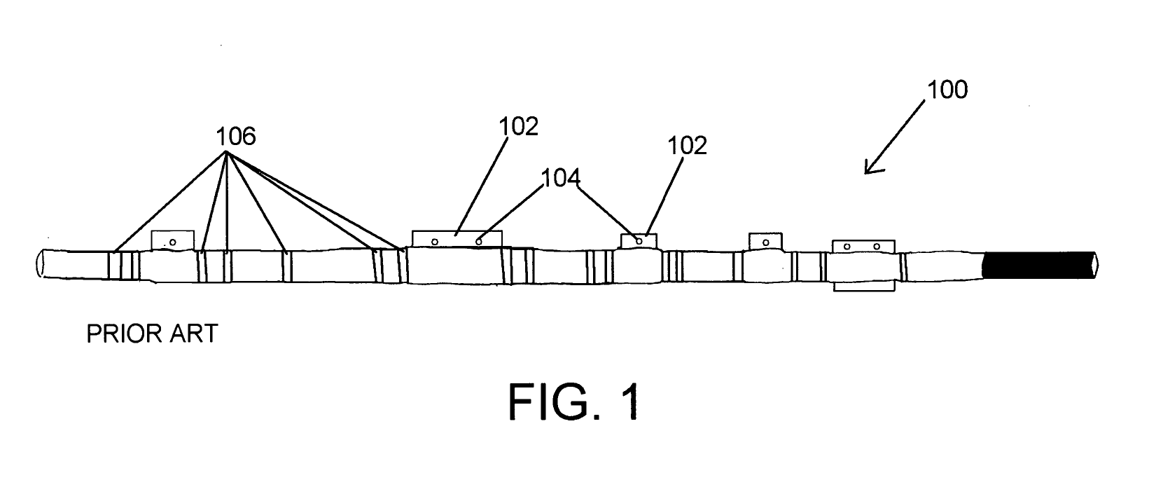

### DETAILED DESCRIPTION

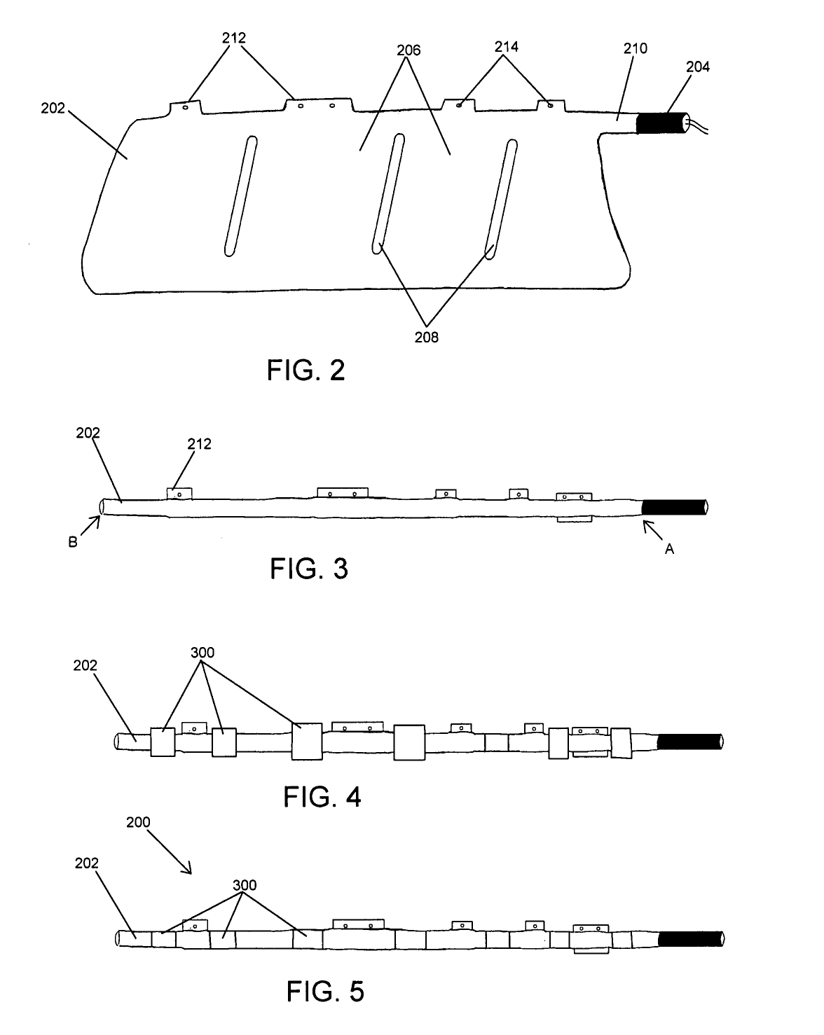

Description of various embodiments of the present invention will be described in reference to the figures. FIG. 2 shows and example of an airbag 202 in the unfolded or unrolled state, which may be used in the airbag module 200 according to an embodiment of the present invention. The airbag 202 may be a curtain airbag used to protect vehicle occupants against impacts with the side portions of the interior cab of a vehicle during a crash event. Although the following disclosure relates to a curtain airbag, other types of airbags are contemplated, such as a head side airbag module, or any other type of airbag module.

Attached to the airbag 202 is a gas generator 204, which is used to inflate the airbag during an event of an emergency. The airbag 202 itself may include one or more inflatable portions 206 divided by seams 208, a passage way 210 that allows fluid communication between the gas generator 204 and the inflatable portions 206, and a series of mounting tabs 212. The mounting tabs 212 includes one or more apertures 214, which are used to mount the airbag to the frame or other supporting structure in the vehicle through the use of alignment pins being fed through the apertures 214.

The airbag 202 may be typically folded or rolled up before it is to be stored, transported, and/or mounted in the vehicle, as seen in FIG. 3.

After the airbag 202 is folded or rolled up, one or more tearable sleeves 300 are slid across the longitudinal direction of the airbag. The tearable sleeve(s) may be made from a shrink wrap film material, which has the ability to shrink from an expanded state with a larger diameter (as seen in FIG. 4) to a contracted state with a smaller diameter after heat is supplied (as seen in FIG. 5). The contracted state with the smaller diameter provides a secure grip so as to keep the air bag in the folded or rolled up condition.

According to one embodiment, the tearable sleeve may be a shrink wrap film, preferably made from polyethylene terephthalate (PETG) polyester but it should be recognized that other suitable materials may be used such as, for example, polyvinyl chloride (PVC), polyolefin, neoprene rubber, Vinton rubber, FEP or PTFE.

Preferable properties of the tearable sleeve may include: a shrink factor in the range of about 50 to about 90%, preferably about 70%; and a thickness in the range of about 0.5 to about 5 mils, preferably about 2 mils. The tearable sleeves may shrink from the expanded state to the contracted state when the application of heat raises the temperature of the tearable sleeve.

According to one embodiment, the tearable sleeves are continuous loops of material, for example shrink wrap tubing. Alternatively, the tearable sleeve may be sheets of film that are wrapped around the airbag, and upon the application of heat, are shrunk and the ends are melted together so as to provide form fitting loops.

In either the tubing or wrapped sheet arrangements, the length of the tubes or sheets may be varied depending on need. As a result, any number of tearable sleeves may be used around portions of the airbag, such as one, two, three, four, five, six, seven (as seen in FIGS. 3-4) or more. The sleeve may extend circumferentially around inflatable portions of the airbag and/or portions that include non-inflatable portions.

Once the one or more tearable sleeves are placed in a suitable position along the folded or rolled up airbag, the assembly may be placed through a heat tunnel or ran past one or more heat guns mounted on an assembly line so as to shrink the tearable film from the expanded state (as seen in FIG. 4) to the contracted state (as seen in FIG. 5). The contracted state of the tearable sleeve is form fitting around the portion of the airbag to which it surrounds. The portion of the airbag circumferentially surrounded by the form-fitting tearable sleeve may be the inflatable portion or a combination of inflatable and noninflatable portions of the airbag.

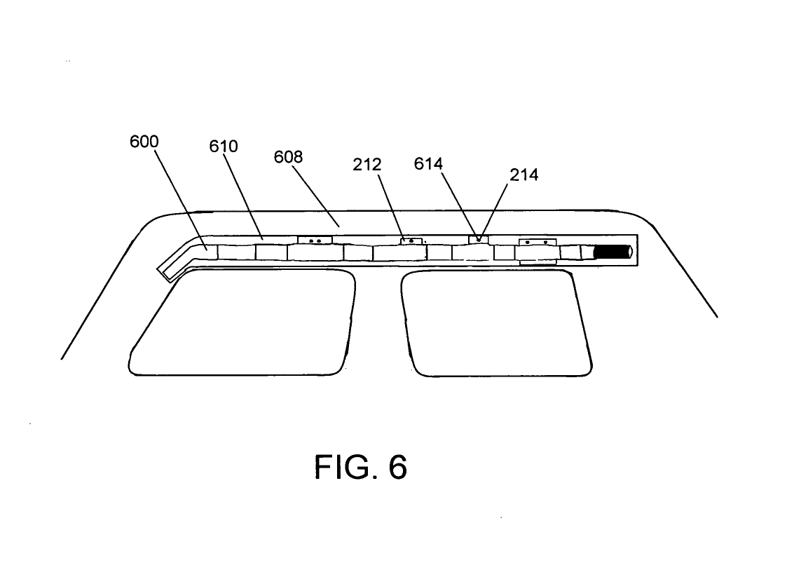

The airbag module 600 assembly is then placed into a storage compartment or location 610 located along the interior roof 608 of the vehicle as seen in FIG. 6. The apertures 214 on the mounting tabs 212 are mounting on fastening pins 614 located in a storage compartment or location 610.

By providing a tearable sleeve in this fashion, multiple pieces of adhesive tape for holding the rolled up or folded airbag may be replaced by a fewer components, which decrease the assembly time and material costs. For example, up to 22 or 23 pieces of adhesive tape may need to be used to provide a state in which the airbag is prevent from being unrolled or unfolded. In contrast, only 4 pieces of tearable sleeves may accomplish the same purpose. Also, the number of personnel may be decreased by using mounted heat guns on an assembly line or a heat tunnel instead of the manual operation of applying the pieces of adhesive tape around the airbag.

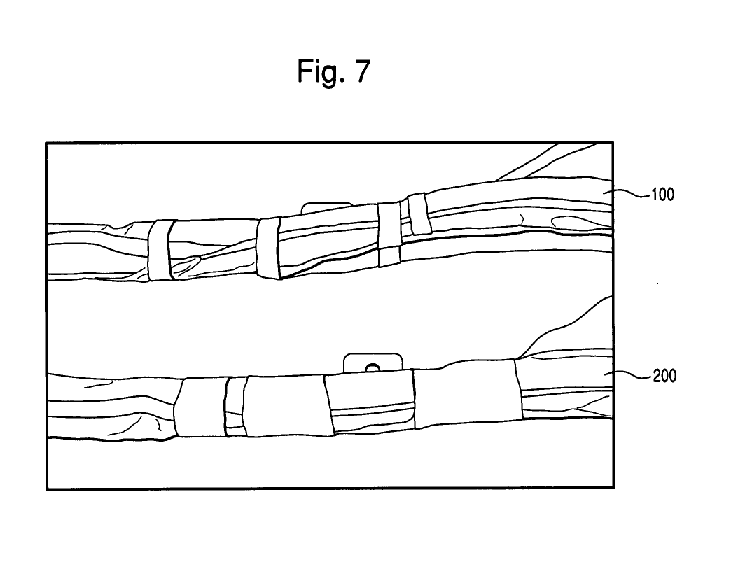

In some applications, the airbag may need to be twisted during the installation of the airbag module 600 into the storage compartment or location 610, for example 90 degrees. In such a case, the tearable sleeves provide the added benefit of keeping the airbag module straighter than if strips of adhesive tape are used, as seen in FIG. 7.

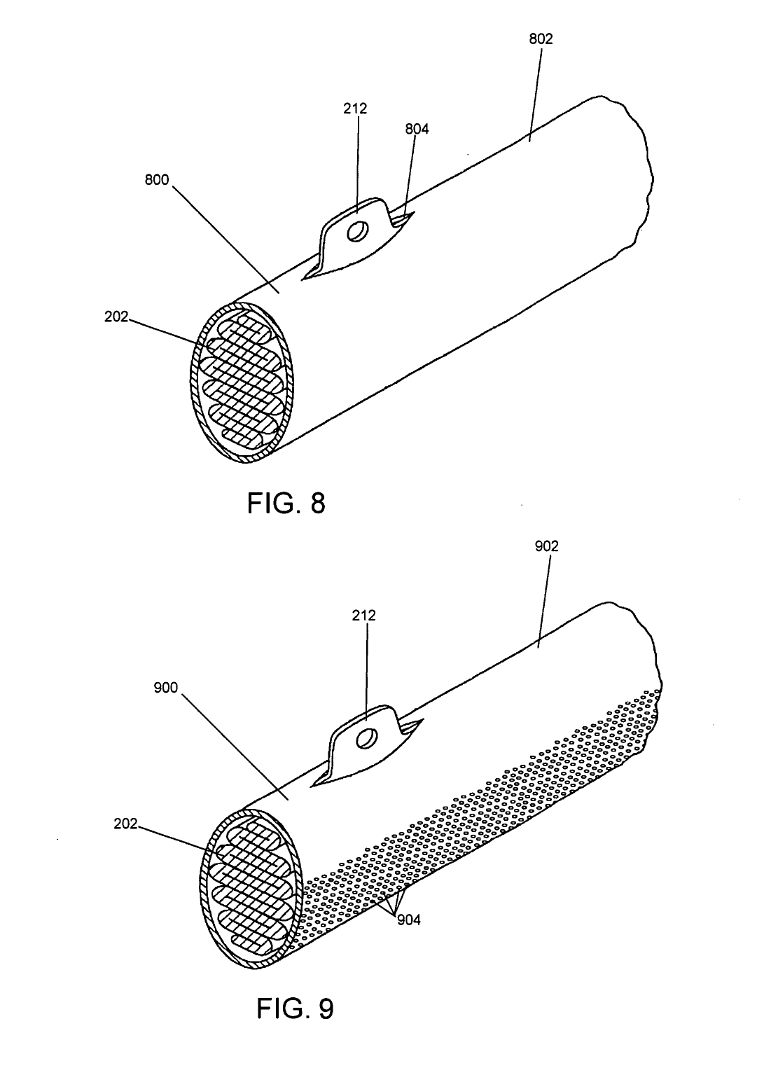

FIG. 8 shows another embodiment of the present invention in which the tearable sleeve 802 extend over the entire length of the airbag 202 wherein the airbag 202 inflates. For example, the tearable sleeve may extend from the gas generator 204 at point A (see FIG. 3) to the end of the airbag 202 at point B. In this example, the mounting tabs 212 extend through slits 804 in the tearable sleeve 802 so that the mounting tabs 212 may extend through the slits 804 and be attached to fastening pins 614 located in a storage compartment 610 located along the interior roof 608 of the vehicle.

In the embodiment of FIG. 8, multiple pieces of adhesive tape for holding the rolled or folded airbag may be replaced by a single component, as well as providing the additional requirements of decreasing the number of personnel and assembly time requirements, as discussed in relation to the embodiment of FIG. 5.

Additionally, the tearable sleeve 802 may be affixed with a label so as to provide suitable identifying information, such as a bar code, the name of the manufacturer, the model or type of airbag module, and/or the like.

FIG. 9 shows another embodiment of the airbag module 900 according to the present invention. This embodiment is similar to the embodiment of FIG. 8 with the addition of adding perforations 904 along a portion of the circumferential surface of the tearable sleeve 902. The perforations 904 may assist in the tearing of the sleeve when the airbag 202 is deployed in the case of an accident. The perforations may only be along a portion of the circumferential surface or around the entire circumferential surface and along a portion of the longitudinal direction of the sleeve or along the entire portion of the sleeve, depending on need. Also, any size perforations may be used depending on the desired resistance to tearing. Additionally or alternatively to the perforations, the tearable sleeve may have a varying thickness in the circumferential and/or longitudinal directions such that the thinner material locations are able to break or tear easier at these locations along the tearable sleeve.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag module for a vehicle, comprising:
an airbag for protecting a vehicle occupant, wherein the airbag is configured to be in a folded or rolled up state and to deploy along an interior side portion of the vehicle; and
at least one tearable sleeve coaxially surrounding a portion of the airbag in the folded or rolled up state,
wherein the at least one tearable sleeve is a shrink wrap film.

2. The airbag module according to claim 1, wherein the shrink wrap film has a shrink factor of about 70%.

3. The airbag module according to claim 1, wherein the shrink wrap film has a thickness of about 2 mils.

4. The airbag module according to claim 1, wherein the shrink wrap film comprises polyethylene terephthalate.

5. The airbag module according to claim 1, wherein the at least one tearable sleeve is a plurality of tearable sleeves surrounding a plurality of portions of the airbag in the folded or rolled up state, wherein the plurality of tearable sleeves have been shrunk after the application of heat.

6. The airbag module according to claim 5, wherein the plurality of tearable sleeves comprises four tearable sleeves.

7. The airbag module according to claim 1, wherein the at least one tearable sleeve has a slot along a circumferential surface.

8. The airbag module according to claim 7, wherein the airbag comprises at least one mounting tab for mounting in the vehicle, wherein the mounting tab is fed through the slot of the at least one tearable sleeve.

9. The airbag module according to claim 1, wherein the at least one tearable sleeve has a plurality of perforations along a portion of the circumferential surface of the tearable sleeve.

10. An airbag module for a vehicle, comprising:
an airbag for protecting a vehicle occupant, wherein the airbag comprises an inflatable portion and a connecting portion for connecting a gas generator, wherein the airbag is configured to be in a folded or rolled up condition;
at least one tearable sleeve located circumferentially around a portion of the inflatable portion of the air bag when in the folded or rolled up condition;
wherein the at least one tearable sleeve is configured to shrink around the inflatable portion of the air bag to provide a form fit after being subjected to an application of heat.

11. The airbag module according to claim 10, wherein the at least one tearable sleeve is a shrink wrap film with a shrink factor of about 70%.

12. The airbag module according to claim 11, wherein the shrink wrap film comprises polyethylene terephthalate.

13. The airbag module according to claim 10, wherein the at least one tearable sleeve has a thickness of about 2 mils.

14. The airbag module according to claim 10, wherein the at least one tearable sleeve is a plurality of tearable sleeves surrounding a plurality of portions of the airbag in the folded or rolled up state.

15. The airbag module according to claim 10, wherein the at least one tearable sleeve has a plurality of perforations along a portion of the circumferential surface of the tearable sleeve.
